(19) United States
(12) Patent Application Publication
(10) Pub. No.: US 2024/0075830 A1
(43) Pub. Date: Mar. 7, 2024

(54) Charging Cable and Method for Charging an Electric Vehicle

(71) Applicant: Juice Technology AG, Cham (CH)

(72) Inventor: Christoph ERNI, Bachenbülach (CH)

(73) Assignee: Juice Technology AG, Cham (CH)

(21) Appl. No.: 18/268,766

(22) PCT Filed: Dec. 16, 2021
(86) PCT No.: PCT/EP2021/086215

§ 371 Date: Jun. 21, 2023

(30) Foreign Application Priority Data
Dec. 21, 2020 (DE) 10 2020 134 489.9

(51) Int. Cl. B60L 53/18; B60L 53/16

(52) U.S. Cl. CPC B60L 53/18; B60L 53/16

(57) ABSTRACT

A charging cable (2) according to the invention for charging an electric vehicle (4) comprises a supply-grid-side first connector (6), a load-side second connection (10), and an adapter assemble (12) between the first and the second connection (6, 10). The adapter assembly (12) comprises a first and a second adapter element (14, 16) which are detachably connected, and a locking device (26) which is designed to automatically lock the first and the second adapter element (14, 16) together when connected.

The present invention relates to a charging cable and to a method for charging an electrical load, in particular an electric vehicle.

Electrical consumers or loads, in particular electric vehicles, are connected to the power network by means of a charging cable in order to be charged. In order to be able to choose the charging location as flexibly as possible and independently of the charging infrastructure available in each case, charging cables are known, the network-side connection of which is replaceable by means of an adapter assembly. It is thereby possible, in a simple manner, to use different connections on the network-side, such as single-phase Schuko plug connectors, three-phase CEE plug connectors or IEC type 2 adapters, for example, as a result of which the charging cable can be adapted to the charging or connection options presently available.

If the charging is being performed in publicly accessible areas, such as in parking lots, multi-storey car parks or underground car parks, there is the risk of the adapter assembly being disconnected and of the charging cable, or parts thereof, being stolen, the charging process being ended without authorization or the charging current being supplied to another load. In order to prevent this, (combination) locks, for example, have been used to date, by means of which the components of the adapter assembly are secured to one another. These predominantly manual activities generate an additional effort, however, which, alongside the amount of time required, is undesirable in particular in adverse outdoor conditions, and renders the charging process, and therefore also the use of electric vehicles, more unattractive.

It is therefore an object of the present invention to provide a charging cable and a method for charging an electrical load, which allow a charging that is as simple and as flexible as possible, but at the same time secure.

This object is achieved by the subject matter of claims 1 and 13, respectively. Preferred embodiments are the subject of the dependent claims.

A charging cable, according to the invention, in particular for charging an electric vehicle, comprises a network-side first connector for connecting the charging cable to a power network, a load-side second connector for connecting the charging cable to a load, in particular to the electric vehicle, and an adapter assembly between the first connector and the second connector of the charging cable. The adapter assembly in turn comprises a first adapter element and a second adapter element, which are detachably connected to one another, wherein one of the first and second adapter elements is electrically connected to the first connector and the other one of the first and second adapter elements is electrically connected to the second connector. The adapter assembly furthermore comprises a locking device which is configured to automatically lock the first and second adapter elements to one another in a connected state in response to an event linked to the charging process.

In this manner, a charging cable is provided, the network-side first connector of which is replaceable in a simple manner by disconnecting the adapter assembly, while the automatic locking of the adapter assembly by means of the locking device spares a user from manually securing and releasing the adapter assembly to replace the first connector. In particular in the event of snow, ice, the cold or soiling, this contributes considerably to the operating comfort of the charging cable. At the same time, during use thereof, the charging cable is protected against unwanted manipulation in the region of the adapter assembly, e.g. through unauthorized disconnection of said adapter assembly.

In the connected state, the adapter assembly connects the first and second connectors both physically and electrically. In the connected state, the first and second adapter elements are engaged with one another, for example by the first and second adapter elements being manually plugged together. The engagement of the first and second adapter elements is detachable, for example by the first and second adapter elements being manually pulled apart from one another. The charging cable can be equipped with different network-side first connectors in a simple manner by disconnecting or detaching the first and second adapter elements from one another. The first and second adapter elements preferably are connected and detached in a connection direction. One of the first and second adapter elements can be in the form of a plug and the other one of the first and second adapter elements can be in the form of a corresponding socket.

In the connected state, the first and second adapter elements are at least at times locked to one another by means of the locking device. The locking takes place automatically, and therefore without the user manually activating the locking device. The locking device is particularly preferably furthermore configured to unlock the first and second adapter elements in an automatic or remotely activated manner.

The event that is linked to the charging process, and at which the automatic locking is triggered, is an event that is associated with the charging process. This allows the locking to take place only if the user has connected the charging cable or starts the charging process. Until then, the charging cable can be handled as desired without hindering the user due to premature or uncontrollable locking. Nevertheless, secure and reliable locking is guaranteed.

In this case, the event can relate directly to the charging process, for example it can be the starting of the charging process. The charging process can start automatically, as soon as the charging cable is connected to the power network and the load. However, the charging process can also start automatically at a predetermined time or after a predetermined delay. Finally, the charging process can also be started by the user, for example by way of appropriate input on a charge control device or a charging station.

However, the event linked to the charging process can also be the step of connecting the first and second adapter elements or the step of connecting of the second connector to the vehicle. The connections put the charging cable into a state in which it enables the charging process. These two processes are necessary to be able to start the charging process and are therefore linked thereto. Depending on the design of the charging cable and/or a charging device or charging station, further events linked to the charging process are conceivable.

The fact that the locking device automatically locks the first and second adapter elements means that the locking device initiates the locking independently of a user input or (remote) activation of the locking device by the user.

In other words, the locking device is configured to automatically lock the first and second adapter elements depending on the event linked to the charging process, in particular depending on the beginning of the charging process or an event that enables the beginning of the charging process.

The time of the automatic locking, and possibly unlocking, can be settable. The locking device preferably locks the first and second adapter elements from the beginning of a charging process until a release of the locking device. By way of example, the locking device is configured to automatically lock the first and second adapter elements as soon as the second connector is connected to a vehicle.

In order to increase the flexibility, the first connector can be connected to one of the first and second adapter elements by means of a first charging cable portion and the second connector can be connected to the other one of the first and second adapter elements by means of a second charging cable portion. However, it is also conceivable to form the respective connection integrally with the associated adapter element.

The first connector can be a Schuko plug connector, a CEE plug connector, an IEC type 2 adapter or any other household or industrial power connectors. The second connector can be in the form of an IEC type 2 adapter, of type 1, CHAdeMO, CCS or of a similar, commercially available type of charging connections.

In one preferred embodiment, the locking device is formed in the adapter assembly so as to be inaccessible from the outside in the connected state of the first and second adapter elements. As a result, the locking device is not able to be manipulated from the outside in the undamaged state of the adapter assembly, and the first and second adapter elements cannot be unlocked and detached from one another by manual activation of the locking device. This further increases security.

This can advantageously be achieved by virtue of the fact that the first adapter element comprises a first housing and the second adapter element comprises a second housing, which housings terminate with one another, preferably terminate flush with one another, in the connected state of the adapter assembly. The locking device is then accommodated in the first and second housings and is consequently protected from external access.

The locking device is preferably electrically adjustable between a locked state and an unlocked state. As a result, the automatic locking and/or remotely activated locking or unlocking is/are able to be implemented in a particularly simple manner, as emerges from the further description of preferred embodiments herein.

In order to make the charging cable even safer, the locking device is preferably designed to be bistable, so that the current locked state and unlocked state of the locking device is maintained when the locking device is switched off. For example, the first and the second adapter element remain locked to one another in the event of a power failure or if the first connection on the mains side is (undesirably) disconnected from the mains.

Preferably, the first adapter element comprises a first locking element and the second adapter element comprises a second locking element, wherein, in the connected state of the first and second adapter elements, the first and second locking elements engage mechanically in one another in a first position, and are detached from one another in a second position. The effect that the first and second locking elements engage mechanically with one another is preferably achieved in that they are connected to one another in a form-fitting or force-fitting manner.

The first and second locking elements can be accommodated in the first and second housings, respectively, of the respective adapter element. If only one of the first and second locking elements has to be moved in order to move the first and second locking elements between the first and second positions, the respective other locking element can be formed integrally with the respective housing.

The first position of the first and second locking elements corresponds to the locked state of the locking device and therefore the adapter assembly. The second position of the first and second locking elements corresponds to the unlocked state of the locking device and therefore the adapter assembly.

Preferably, the first and second locking elements are configured to move relative to one another between the first and second positions. To this end, the first and second locking elements can be moved translationally or rotationally relative to one another. A translational movement can be effected parallel to the connection direction or transversely to the connection direction. A rotational movement can be effected about an axis that is oriented parallel to the connection direction or transversely to the connection direction. Combined movements are also conceivable.

According to a first embodiment of the locking device, one of the first and second locking elements comprises a groove, and the other one of the first and second locking elements comprises a protrusion that engages in the groove in the first position. The groove does not run parallel, but rather transversely, preferably perpendicular, to the connection direction. The protrusion is accommodated in the groove in a form-fitting manner in the first position. As a result, the first and second adapter elements are locked and cannot be disconnected from one another parallel to the connection direction.

In this embodiment, the first and second locking elements can each be in the form of a pin or a bolt, which include the groove or the protrusion at a free end. That locking element, out of the first and second locking elements, comprising the groove can also, however, be formed integrally with the respective adapter element, out of the first and second adapter elements, in particular with the housing of the adapter element. The groove is then formed into the housing of the respective adapter element.

In a second embodiment of the locking device, the first and second locking elements each comprise a catch, which catches are configured to engage with one another in the first position. The catches preferably have a substantially triangular cross section. The catches are tapered parallel to the connection direction, with the result that, when the first and second adapter elements connect, said catches slide along one another on oblique surfaces of the catches in the connection direction until they latch to one another. If the first and second adapter elements are oriented relative to one another in the connection direction, the two catches are each tapered on a side facing one another, i.e. they taper to a point. In the first position, two surfaces, which run substantially perpendicular to the connection direction, of the catches bear against one another. As a result, the first and second adapter elements are locked and cannot be disconnected from one another parallel to the connection direction.

The first and second locking elements can be of rod-shaped design and can each have a catch at a free end. In this exemplary embodiment, one of the first and second locking elements may also be formed integrally with the respective adapter element, out of the first and second adapter elements, in particular with the housing of the adapter element. This housing then comprises a corresponding protrusion in the form of the catch.

In a third embodiment, the first and second locking elements form a bayonet fastener. To this end, one of the first and second locking elements comprises a sleeve with at least one groove, preferably with two grooves. The at least one groove comprises an axial portion that extends from an edge of the sleeve, which edge is facing the other locking element, in the axial direction of the sleeve. The axial direction is preferably oriented parallel to the connection direction. The at least one groove additionally comprises a tangential portion that extends at the end of the axial portion in the tangential direction of the sleeve. The other one of the first and second locking elements comprises at least one engagement means, such as, for example, a pin or a protrusion, preferably a plurality of engagement means corresponding to the number of grooves. The at least one engagement means extends in a radial direction with respect to the sleeve. That locking element comprising the engagement means can be in the form of a cylindrical (full) body, of a sleeve or of a bolt, which has the at least one engagement means in an end region that is close to the other locking element. Here too, one of the two locking elements may be formed integrally with the respective adapter element, in particular with the housing of the adapter element.

If the first and second locking elements are moved toward one another in the connection direction, the at least one engagement means enters the at least one groove and is displaced along the axial portion of the groove. Rotating the first and second locking elements relative to one another then displaces the engagement means along the tangential portion of the groove, as a result of which the bayonet fastener is closed. The locking device is then in the first position.

In a fourth embodiment of the locking device, one of the first and second locking elements comprises an internal thread, and the other one of the first and second locking elements comprises an external thread, which threads engage in one another in the first position. As soon as the internal thread and the external thread engage in one another, they form a force-fitting connection, as a result of which the first and second adapter elements are locked and can no longer be disconnected from one another parallel to the connection direction. That locking element, out of the first and second locking elements, that comprises the external thread is preferably in the form of a threaded rod. The internal thread may be inserted directly into the other adapter element or into a housing of said adapter element, or may be formed by a threaded insert or as a sleeve having an internal thread, which are fixedly anchored in the adapter element.

Particularly preferably, the locking device furthermore comprises an actuator for moving the first and second locking elements relative to one another between the first position and the second position. The actuator is preferably in the form of an electric motor, stepper motor or electromagnet. If the locking device is electrically adjustable, it is preferably electrically adjustable by means of the actuator.

Irrespective of this, the actuator effects an actuating movement that is configured to lock and/or unlock the locking device. The actuating movement may be oriented parallel to the connection direction or transversely to the connection direction. The actuator may be configured to move the first and second locking elements from the first position to the second position and/or from the second position to the first position.

It is also conceivable for the first and second locking elements to be pretensioned in one of a first and a second position, and for the actuator to move the first and second locking elements from the pretensioned position to the other of the first and second positions.

In the above-described first embodiment, one of the first and second locking elements can be moved by means of the actuator in order to bring the protrusion into engagement with the groove. By way of example, that locking element, out of the first and second locking elements, that comprises the protrusion may be mounted so as to be pivotable. Owing to the actuating movement of the actuator, in the connected state of the adapter assembly, the locking element is pivoted in such a way that the protrusion engages in the groove of the other one of the first and second locking elements. However, that locking element, out of the first and second locking elements, that comprises the protrusion can also be mounted so as to be translationally displaceable, in particular in a direction perpendicular to the connection direction. Owing to the actuating movement of the actuator, in the connected state of the adapter assembly, the locking element is displaced in such a way that the protrusion engages in the groove of the other one of the first and second locking elements.

In the second embodiment, it is preferred for the two catches to be pretensioned relative to one another transversely to the connection direction. If the first and second adapter elements are connected, the two catches are displaced along the oblique surfaces counter to the pretensioning force. As soon as the oblique surfaces end, the pretensioning force causes the locking elements to latch. This state is retained even without energization. In order to unlock the locking device, the actuating movement of the actuator effects a relative movement between the first and second locking elements from the first position to the second position, that is to say substantially transversely to the connection direction. Here too, a locking element can be mounted so as to be pivotable or translationally displaceable, and the actuating movement of the actuator moves this locking element from the first position to the second position.

In the third and fourth embodiments, the first and second locking elements are able to rotate relative to one another about an axis parallel to the connection direction, and the actuating movement of the actuator rotates one of the first and second locking elements, that is to say from the second position to the first position and back, for the purpose of locking and unlocking. In the third embodiment, part of a full revolution is sufficient for this, corresponding to the length of the tangential portion of the groove of the bayonet fastener. In the fourth embodiment, a plurality of revolutions is required to bring a sufficient number of thread turns of the external thread and the internal thread into engagement with one another.

It is furthermore preferred for the charging cable to comprise a control unit, for controlling the locking device, which is communicatively connected to the first and/or the second connector and the locking device. The control unit is configured to recognize the event linked to the charging process and, in response to the event linked to the charging process, to actuate the locking device in such a way that the locking device locks the first and second adapter elements to one another.

In particular, the control unit is configured to cause the locking device to move from the unlocked state to the locked state and/or from the locked state to the unlocked state, or to cause the first and second locking elements to move from the second position to the first position and/or from the first position to the second position. To this end, the control unit preferably actuates the actuator.

The control unit can be accommodated in the adapter assembly, in particular in that adapter element, out of the first and second adapter elements, that contains the movable locking element or the actuator. The control unit can, however, also be formed separately, and for example can be arranged in a charge control device fixedly connected to the charging cable.

In order to guarantee simple handling and space-saving accommodation of the charging cable in a vehicle, the adapter assembly, in particular the first and second adapter elements, has a diameter that is at most 200 mm, preferably at most 100 mm, more preferably at most 60 mm. In addition, in the connected state, the adapter assembly should have a length that is between 50 mm and 500 mm, preferably between 75 mm and 300 mm, more preferably between 100 mm and 200 mm. As a result, the adapter assembly is as compact as possible.

The invention also relates to a mobile charging device for charging an electric vehicle, comprising a charging cable according to the invention. The charging device comprises a charging regulation apparatus, for regulating a charging process, which is arranged between one of the first and second connectors and the adapter assembly. The charge control device is configured to regulate parameters of the charging process, such as the charging power or charging current intensity, for example. Preferably, the charge control device is arranged between the load-side second connector and the adapter assembly, and is electrically connected to the second connector and that adapter element, out of the first and second adapter elements, that is connected to the second connector.

A method, according to the invention, for charging an electric vehicle comprises:
providing a charging cable that comprises a network-side first connector for connecting the charging cable to a power network, a load-side second connector for connecting the charging cable to the electric vehicle, and an adapter assembly between the first connector and the second connector of the charging cable, wherein the adapter assembly comprises a first adapter element and a second adapter element, which are able to be detachably connected to one another;
connecting the first and second adapter elements to one another;
connecting the first connector to the power network and the second connector to the electric vehicle;
locking the first and second adapter elements to one another by means of the locking device;
wherein the locking takes place automatically in response to an event linked to the charging process.

In this manner, a method for charging an electric vehicle is provided, in which a network-side first connector of the charging cable is replaceable in a simple manner by disconnecting the adapter assembly, while the automatic locking of the adapter assembly by means of the locking device spares a user from manually securing the adapter assembly. In particular in the event of snow, ice, the cold or soiling, this contributes considerably to the operating comfort of the charging cable and saves time. At the same time, the charging cable is protected against unwanted manipulation.

The method is preferably carried out by means of a charging cable according to the invention and therefore comprises the provision of a charging cable, according to the invention, as described at the outset. All the features and advantages that have been described with respect to the charging cable according to the invention are therefore able to be transferred analogously to the method, and vice versa. The method can also be carried out by means of the mobile charging device described.

The method preferably furthermore comprises the unlocking of the first and second adapter elements by means of the locking device, wherein the unlocking takes place automatically in response to an event linked to the charging process, or as a result of remote activation by a user. The user is therefore also spared from manually releasing the adapter assembly, as a result of which the operating comfort is increased further.

If the locking takes place automatically, the event linked to the charging process can be the step of connecting the first and second adapter elements, the connection of the second connector to the vehicle, or the starting of the charging process by a charging device.

If the event linked to the charging process is the connection of the second connector to the vehicle, the method preferably comprises the recognition of a connected vehicle, for example by means of a control pilot, and the locking of the first and second adapter elements in response to the recognition of the vehicle. The connected vehicle can be recognized by means of the charging regulation apparatus, which is communicatively connected to the second connector.

If the event linked to the charging process is the starting of the charging process by a charging device, the method comprises, for example, the locking of the first and second adapter elements in response to the connection of the charging current or in response the activation of an operating element by the user, said locking being provided to start the charging process at the charging device or a charging station.

In the case of unlocking, the event linked to the charging process can be the removal or the unplugging of the second connector from the vehicle. The method then comprises the recognition that there is no longer a vehicle connected, preferably by means of a control pilot, and the unlocking of the first and second adapter elements in response to the recognition that there is no longer a vehicle connected. In the case of unlocking, the event linked to the charging process can also be the ending of the charging process. However, an authentication check should therefore be carried out to prevent unwanted manipulations. By way of example, the unlocking can then take place in response to the confirmation of the end of the charging process at the charging device following identification of the user, in response to a payment process at the charging device, or in response to the vehicle being unlocked.

If the unlocking takes place as a result of remote activation by the user, the method preferably comprises remote activation by means of an activation element on the first or on the second connector, by means of an input apparatus on the charging device, for example on the charging regulation apparatus, or by means of a mobile terminal, such as by means of an app on a smartphone, for example, that is communicatively connected to the control unit of the locking device. Care should be taken to ensure that this is only enabled for an authorized operator.

In all the embodiments, the authorization of the operator can be carried out, for example, by input of a code, by recognition of a fingerprint or by wireless identification, by means of RFID, NFC, WLAN, Bluetooth or the like, of a security feature, for example by way of communication with the user's smartphone, a vehicle key or tag that the user carries.

In all cases, the locking or unlocking can take place immediately in response to the event linked to the charging process or after a predetermined time following the event, for example by means of a timer.

Further advantages and features of the present invention emerge from the following description with reference to the drawings.

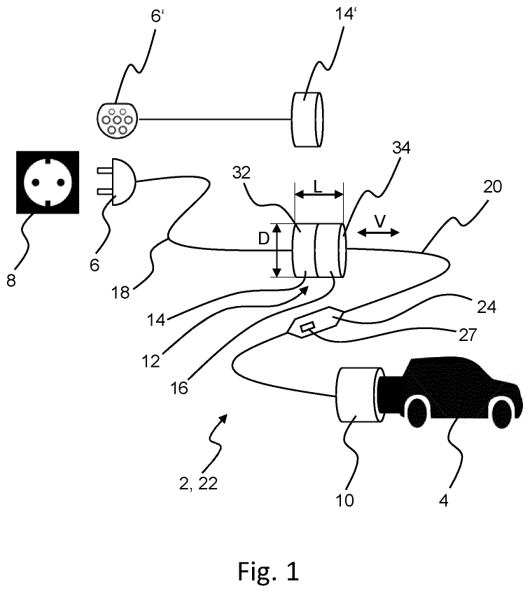

FIG. 1 schematically shows a charging cable according to the invention and a charging device comprising the charging cable according to the invention.

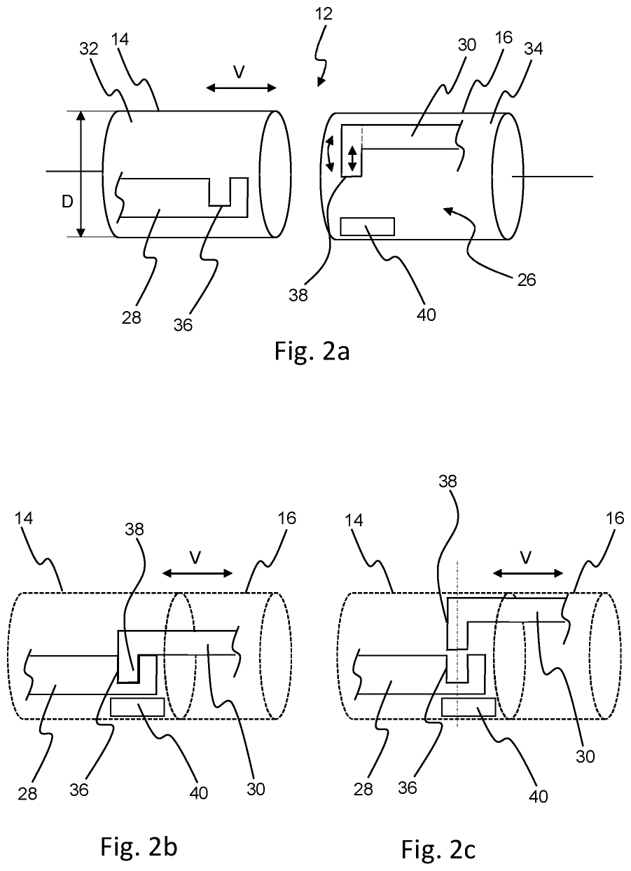

FIGS. 2a-c schematically show an adapter assembly of the charging cable according to FIG. 1, comprising a locking device according to a first embodiment.

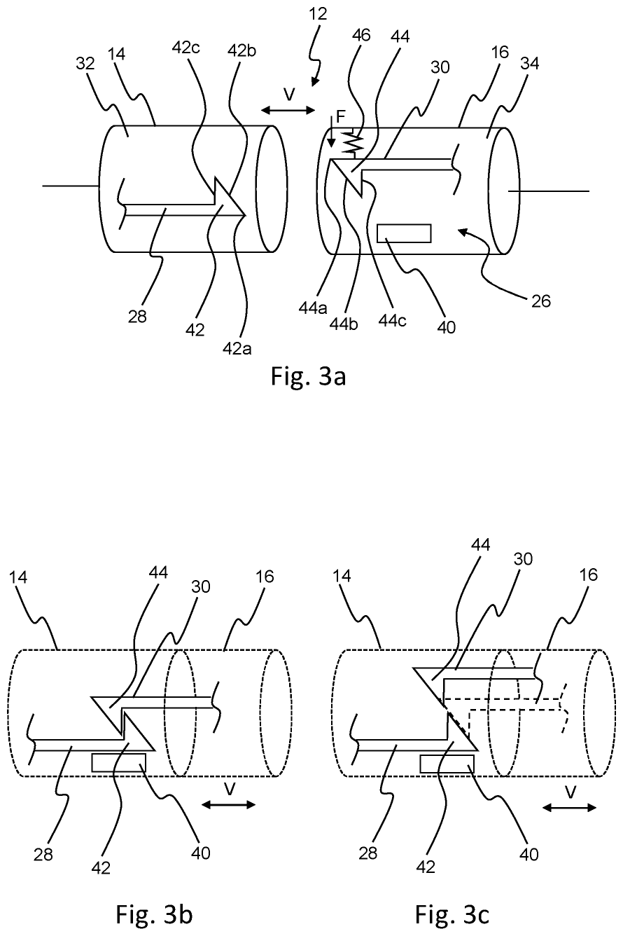

FIGS. 3a-c schematically show an adapter assembly of the charging cable according to FIG. 1, comprising a locking device according to a second embodiment.

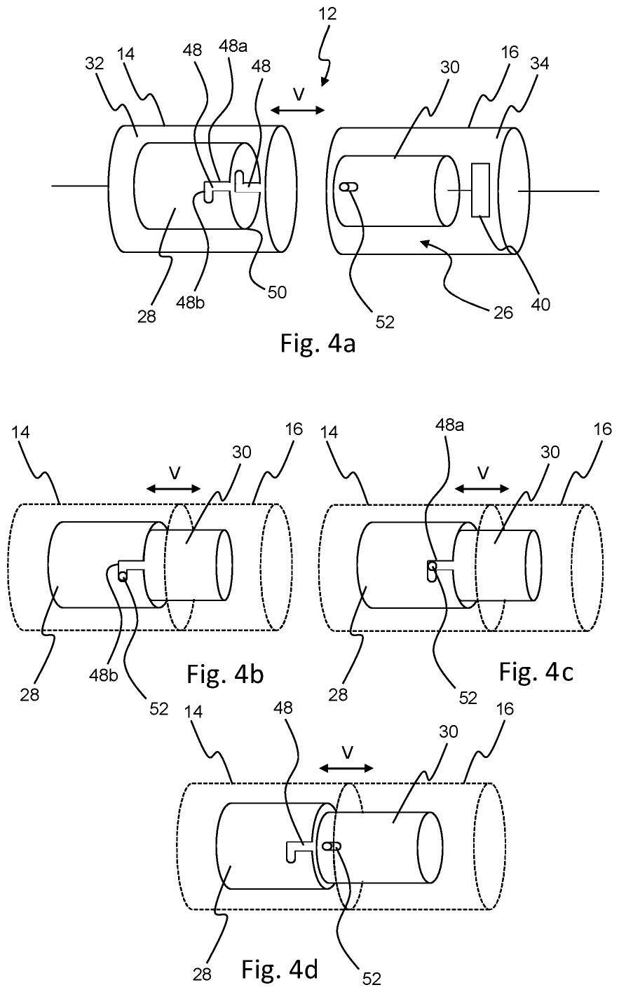

FIGS. 4a-d schematically show an adapter assembly of the charging cable according to FIG. 1, comprising a locking device according to a third embodiment.

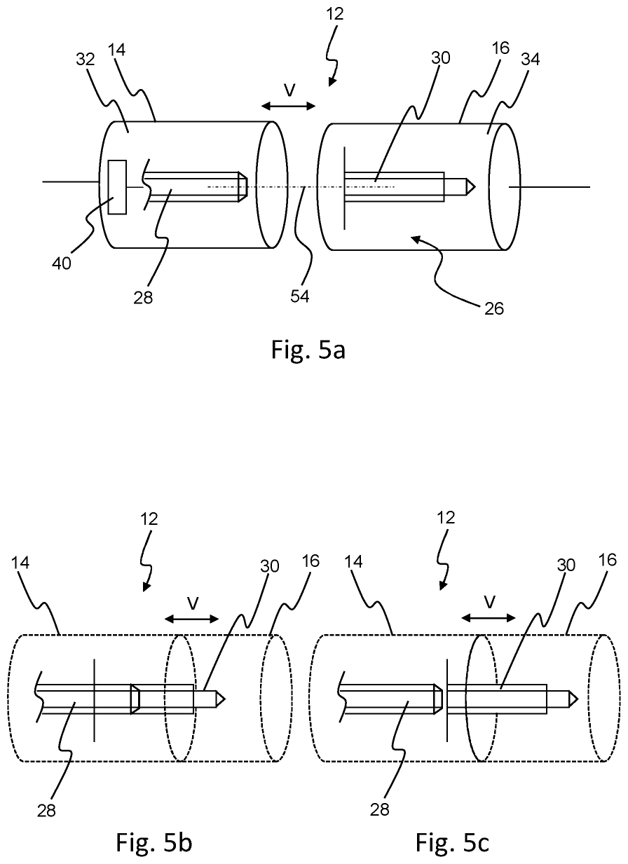

FIGS. 5a-c schematically show an adapter assembly of the charging cable according to FIG. 1, comprising a locking device according to a fourth embodiment.

FIG. 1 shows a charging cable 2, according to the invention, for charging an electric vehicle 4. The charging cable 2 comprises a network-side first connector 6 for connecting the charging cable 2 to the power network or grid, which is depicted symbolically by the plug socket 8, and a load-side second connector 10 for connecting the charging cable 2 to the electric vehicle 4. The charging cable 2 furthermore comprises an adapter assembly 12 between the first connector 6 and the second connector 10 of the charging cable 2. The adapter assembly 12 comprises a first adapter element 14 and a second adapter element 16, which are detachably connected to one another, and are preferably in the form of plug connections for this purpose. The first and second adapter elements 14, 16 can be connected to one another and detached from one another in a connection direction V. In this exemplary embodiment, the first adapter element 14 is electrically connected to the first connector 6 and the second adapter element 16 is electrically connected to the second connector 10. For this purpose, the first adapter element 14 can be connected to the first connector 6 by means of a first charging cable portion 18 and the second adapter element 16 can be connected to the second connector 10 by means of a second charging cable portion 20.

In order to enable charging of the electric vehicle 4 as independently as possible from the respectively present connection to the power network 8, differently designed second connectors 10 can be used by way of the adapter assembly 12. By way of example, an alternative embodiment of a second connector 6′ is shown, which can be connected to the second adapter element 16, and therefore to the remaining charging cable 2, by means of a first adapter element 14′.

In this case, the second connector is in the form of a Schuko plug, for example, whereas the further second connector 6′ is in the form of an IEC type 2 adapter. A CEE plug connector design would also be conceivable.

A mobile charging device 22 is provided by virtue of a charge control device 24 for regulating the charging process being provided, which charge control device is preferably arranged between the vehicle-side second connector 10 and the second adapter element 16, and is electrically connected thereto. As a result, the electric vehicle 4 can be charged particularly well in a manner that is mobile and independent of a permanently installed charging station. In addition, the charge control device 24 can be at least communicatively connected to the second connector 10 in order to recognize, for example, whether the second connector 10 is connected to the electric vehicle 4.

The adapter assembly 12 of the charging cable 2 according to the invention furthermore comprises a locking device 26 that is configured to automatically lock the first and second adapter elements 14, 16 to one another in a connected state of said adapter elements. Different embodiments of the locking device 26 are shown in FIGS. 2-5 and described below. In order to control the locking device 26, the charging cable 2 comprises a control unit 27, which is communicatively connected to the first and/or the second connector 6, 10 and the locking device 26. By way of example, the charge control device 24 can comprise the control unit 27, as shown in FIG. 1.

With reference to FIGS. 2-5, the locking device 26 fundamentally comprises a first locking element 28 and a second locking element 30, wherein the first locking element 28 is assigned to the first adapter element 14 and the second locking element 30 is assigned to the second adapter element 16. In the connected state of the first and second adapter elements 14, 16, the first and second locking elements 28, 30 engage mechanically in one another in a first position, whereas they are detached from one another in a second position.

The first adapter element 14 can have a first housing 32 that accommodates the first locking element 28, and the second adapter element 16 can have a second housing 34 that accommodates the second locking element 30. In one preferred embodiment, the locking device 26 is formed in the adapter assembly 12 so as to be inaccessible from the outside in the connected state of the first and second adapter elements 14, 16. This can be achieved in a particularly simple manner by virtue of the first and second housings 32, 34 substantially terminating with one another in the connected state, as shown in FIG. 1, as a result of which access to the components of the locking device 26 is prevented.

A maximum diameter D of the adapter assembly 12 is designated in FIG. 1 and generally corresponds to the diameter of the first or the second adapter element 14, 16, in particular the diameter of the respective housing 32, 34, as is shown by way of example for all the embodiments in FIG. 2a. It goes without saying that the housings 32, 34 can also have an oval cross section, a substantially rectangular, or a polygonal cross section. The diameter D then also corresponds to a width or height of the respective housing.

In addition, in the connected state of the first and second adapter elements 14, 16, the adapter assembly 12 has a length L parallel to the connection direction V, said length likewise being substantially determined by the dimensions of the housings 32, 34 of the first and second adapter elements 14, 16.

FIGS. 2a-c schematically show, in magnified form, the adapter assembly 12 comprising a locking device 26 according to a first embodiment. The first locking element 28 comprises a groove 36 and the second locking element 30 comprises a protrusion 38 that is dimensioned in such a way that it can engage in the groove 36. The groove 36 preferably runs perpendicular to the connection direction V. It goes without saying that, alternatively, the second locking element 30 can also have the groove 36 and the first locking element can have the protrusion 38, and the following explanations are also able to be transferred analogously to such an embodiment. In FIGS. 2b and 2c, the adapter assembly 12 is shown in the connected state.

In the first position shown in FIG. 2b, the protrusion 38 engages in the groove 36. The first and second locking elements 28, 30 are thereby connected to one another in a form-fitting manner parallel to the connection direction V, and cannot be disconnected. The adapter assembly 12 is therefore in a locked state.

In the second position that is shown in FIG. 2c, the first and second locking elements 28, 30 are detached from one another. The protrusion 38 does not engage in the groove 36 and the first and second adapter elements 14, 16 can be disconnected from one another and connected to one another parallel to the connection direction V. The adapter assembly 12 is therefore in an unlocked state.

The first and second locking elements 28, 30 are able to move relative to one another between the first and second positions. For this purpose, at least one of the first and second locking elements 28, 30 is mounted so as to be movable. As indicated by the two arrows on the protrusion 38, it is possible, for example, for the second locking element 30 to be mounted so as to be pivotable or linearly displaceable perpendicular to the connection direction V. If the second locking element 30 is mounted so as to be pivotable, it is preferably in the form of a bolt, wherein one end of the bolt is mounted appropriately and an opposite, free end has the protrusion 38. A linearly displaceable second locking element 30 can also be of bolt-shaped design. It can also just be in the form of a pin, however, which forms the protrusion 38, as indicated using dashed lines in FIG. 2a.

The locking device 26 comprises an actuator 40 for moving the first and second locking elements 28, 30 between the first position and the second position. The actuator 40 is preferably accommodated in that adapter element, out of the first and second adapter elements 14, 16, in which the movable locking element 28, 30 is also located.

By way of example, the actuator 40 can be in the form of an electric motor that pivots or linearly displaces the second locking element 30. In the embodiment shown, the actuator 40 can also be in the form of an electromagnet that moves the second locking element 30 between the first and second positions. To this end, the second locking element 30 is at least partially magnetic. The actuator 40 can then pull the protrusion 38 into the groove 36 or push it out of the groove 36.

If one of the first and second locking elements 28, 30, such as the first locking element 28 in this case, is immovable, it can be formed integrally with the respective housing 32, 34 of the first or second adapter element 14, 16. The respective housing 32, 34 can therefore have either a groove or a protrusion.

FIGS. 3a-c schematically show, in magnified form, a second embodiment of the locking device 26. According to this embodiment, the first locking element 28 has a first catch 42 and the second locking element 30 has a second catch 44. The first and second catches 42, 44 have a substantially triangular cross section and are designed to be tapered parallel to the connection direction V, with the result that a tip 42a of the first catch 42 and a tip 44a of the second catch 44 are directed to an open end of the respective adapter element 14, 16. The first and second locking elements 28, 30 therefore have corresponding oblique surfaces 42b, 44b that run obliquely with respect to the connection direction V. In addition, the first and second locking elements 28, 30 each have a straight surface 42a, 44c that each run perpendicular to the connection direction V at one end of the oblique surfaces 42b, 44b that is remote from the tip 42a, 44a.

In the first position that is shown in FIG. 3b, the first and second catches 42, 44 engage with one another. In this case, the straight surfaces 42c, 44c of the first and second catches 42, 44 bear against one another and thereby form a form-fitting connection parallel to the connection direction V. As a result, the first and second adapter elements 14, 16 cannot be disconnected from one another parallel to the connection direction V and the adapter assembly 12 is in the locked state.

FIG. 3c shows the first and second locking elements 28, 30 in the second position, in which they are detached from one another in the connected state of the adapter elements 14, 16. The straight surfaces 42c, 44c of the first and second catches 42, 44 do not make contact with one another and the first and second adapter elements 14, 16 can be disconnected from one another and connected to one another parallel to the connection direction V. The adapter assembly 12 is therefore in the unlocked state.

In this embodiment too, the first and/or second locking element 28, 30, in a similar manner to the first embodiment, can be mounted so as to be pivotable or linearly displaceable, and can be moved between the first and second positions by means of the actuator 40. In addition, one of the first and second locking elements 28, 30, which is not mounted so as to be movable, can be formed integrally with the housing 32, 34 of the respective adapter element 14, 16.

It is, however, preferred for one of the first and second locking elements 28, 30 to be pretensioned by a pretensioning element 46, in particular a spring element, such as a compressive spring, substantially perpendicular to the connection direction V. The pretensioning element 46 exerts a pretensioning force F on the respective locking element 28, 30.

In the disconnected state of the adapter assembly 12, which is shown in FIG. 3a, the second locking element 30 pretensioned by means of the pretensioning element 46 is in a rest position. If the first and second adapter elements 14, 16 are connected to one another in the connection direction V, the oblique surfaces 42b, 44b of the first and second catches 42, 44 initially meet one another and slide against one another. In the process, the second locking element 30 is displaced counter to the pretensioning force F of the pretensioning element 46, as indicated in FIG. 3c by the two positions of the second locking element 30. As soon as the oblique surfaces 42b, 44b are no longer supported on one another perpendicular to the connection direction V, as in FIG. 3c in the top position of the second locking element 30, the pretensioning element 46 causes the first and second catches 42, 44 to latch. The pretensioning force F displaces the second catch 44 perpendicular to the connection direction V, such that the straight surfaces 42c, 44c of the first and second catches 42, 44 bear against one another and the locking device 26 is in the first position shown in FIG. 3b.

The actuator 40 can then move the second locking element 30 back to the second position. This can take place as a result of the actuator 40 mechanically transferring an actuating movement to the second locking element 30, which movement is oriented perpendicular to the connection direction V and counter to the pretensioning force F. The actuator 40 can, however, also be in the form of an electromagnet and can, perpendicular to the connection direction V and counter to the pretensioning force F, effect a magnetic force on the locking element 30, which is at least partially magnetic.

FIGS. 4a-d show the adapter assembly 12 comprising a locking device 26 according to a third embodiment. In this case, the first and second locking elements 28, 30 form a bayonet fastener. In the exemplary embodiment shown, the first locking element 28 is in the form of a sleeve that has at least one groove 48. The groove 48 in turn has an axial first groove portion 48a that extends in the axial direction parallel to the connection direction V from an edge 50 of the sleeve 28, which edge is facing the second adapter element 16. In addition, the groove 48 has a tangential second groove portion 48b that extends in the circumferential direction of the sleeve 28 at that end of the first groove portion 48a that is averted from the edge 50. The second locking element 30 has at least one engagement means 52 that is dimensioned in such a way that it is able to be inserted into the groove 48 and is able to be moved along the groove 48. Accordingly, a diameter of the engagement means 52 is at most as large as a width of the groove 48. The engagement means 52 is oriented radially with respect to the connection direction V and can be cylindrical. The second locking element 30 can be in the form of a pin that extends parallel to the connection direction V, and that has the engagement means 52 in the region of a free end that is facing the first adapter element 14. In order to connect the first and second adapter elements 14, 16, there are in each case a groove 48 and an engagement means 52 in the circumferential direction in a corresponding position. In this embodiment too, one of the first and second locking elements 28, 30 can be formed integrally with the housing 32, 34 of the respective adapter element 14, 16.

In the first position that is shown in FIG. 4b, the first and second locking elements 28, 30 engage in one another. The at least one engagement means 52 is located in the second groove portion 48b, preferably at the closed end of the second groove portion 48b of the groove 48. The first and second locking elements 28, 30 are thereby connected to one another in a form-fitting manner parallel to the connection direction V, and cannot be disconnected. The adapter assembly 12 is therefore in the locked state.

Rotating the first and second locking elements 28, 30 relative to one another in the circumferential direction of the sleeve 28 moves the at least one engagement means 52 into the first groove portion 48a, as shown in FIG. 4c. The first and second locking elements 28, can then be detached from one another parallel to the connection direction V, and can be moved to the second position according to FIG. 4d.

In this embodiment, the actuator 40 exerts a rotational actuating movement on one of the first and second locking elements 28, 30, in order to rotate said elements relative to one another in the circumferential direction between the positions shown in FIGS. 4b and 4c. By way of example, the actuator can rotate the pin 30, but alternatively also the sleeve 28, about an axis parallel to the connection direction V by means of a magnet, electric motor or stepper motor. The displacement of the engagement means 52 along the axial first groove portion 48a can be effected parallel to the connection direction V together with the connection or disconnection of the first and second adapter elements 14, 16.

Finally, FIGS. 5a-c schematically show a fourth embodiment of the locking device 26, in which the first locking element 28 has an external thread and the second locking element 30 has an internal thread that corresponds to the external thread. The external thread and the internal thread engage in one another in the first position, as shown in FIG. 5b. By way of example, the first locking element 28 is in the form of a threaded rod and the second locking element is in the form of a threaded insert or a sleeve having an internal thread, which is recessed into the second housing 34 of the second adapter element 16. The first locking element 28 could also readily have an internal thread and the second locking element 30 an external thread.

If the first and second adapter elements 14, 16, so as to be connected to one another, are oriented relative to one another in the connection direction V, the external thread of the first locking element 28 and the internal thread of the second locking element 30 are also oriented relative to one another along an axis 54 parallel to the connection direction V. In this exemplary embodiment, the actuator 40 exerts a rotational actuating movement preferably on the first locking element 28 having the external thread, as a result of which the first locking element 28 can be screwed into the second locking element 30 or out of the second locking element 30.

The method according to the invention is described below with reference to FIGS. 1-5 and can be considered substantially independently of the specific embodiment of the locking device 26.

The method for charging an electric vehicle 4 first comprises the provision of a charging cable 2 comprising the first and second connectors, 6, 10 and the adapter assembly 12, as described above. Firstly, the first and second adapter elements 14, 16 are connected to one another, preferably plugged together in the connection direction V, as shown in FIG. 1, as well as FIGS. 2b and c, FIGS. 3b and c, FIGS. 4b-d and FIGS. 5b and c. Subsequently, the first connector 6 can be connected to the power network 8 and the second connector 10 to the electric vehicle 4 (see FIG. 1).

In order to avoid unauthorized disconnection of the adapter assembly 12, the method furthermore comprises the locking of the first and second adapter elements 14, 16 by means of the locking device 26. This is in particular achieved by the movement of the first and second locking elements 28, 30 relative to one another from the second position (cf. FIGS. 2c, 3c, 4d and 5c) to the first position (cf. FIGS. 2b, 3b, 4b and 5b), in which the first and second locking elements 28, 30 engage mechanically in one another, as described above.

The locking of the first and second adapter elements 14, 16 takes place automatically in response to an event linked to the charging process. Similarly, the unlocking of the first and second adapter elements 14, 16 can take place automatically in response to an event linked to the charging process, or else as a result of remote activation by a user.

The unlocking is in particular achieved by moving the first and second locking elements 28, from the first position (cf. FIGS. 2b, 3b, 4b and 5b) to the second position (cf. FIGS. 2c, 3c, 4d and 5c), as a result of which the first and second locking elements 28, 30 are detached from one another. The first and second adapter elements 14, 16 can then be disconnected from one another parallel to the connection direction V.

It is therefore ensured, using the charging cable and method according to the invention, that the charging cable 2, or parts thereof, cannot be stolen and the charging process cannot be interrupted without authorization. Manual handling of the adapter assembly 12 or of a locking device 26 on said adapter assembly by the user is not required, as a result of which operating comfort is increased.

1-15. (canceled)

16. A charging cable for charging an electric vehicle, the charging cable comprising:
a network-side first connector for connecting the charging cable to a power network;
a load-side second connector for connecting the charging cable to the electric vehicle; and
an adapter assembly between the first connector and the second connector, the adapter assembly including:
a first adapter element and a second adapter element detachably connected to one another, wherein one of the first and second adapter elements is electrically connected to the first connector and the other one of the first and second adapter elements is electrically connected to the second connector; and
a locking device configured to automatically lock the first and second adapter elements to one another in response to an event associated with charging the electric vehicle.

17. The charging cable of claim 16 wherein the locking device is formed in the adapter assembly to be inaccessible from the outside while the first and second adapter elements are connected to one another.

18. The charging cable of claim 16 wherein the locking device is bistable, such that the locking device is either in a locked or unlocked state, and the state of the locking device is maintained when the locking device is de-energized.

19. The charging cable of claim 16 wherein the first adapter element includes a first locking element and the second adapter element includes a second locking element, and while the first and second adapter elements are connected to one another, the first and second locking elements engage mechanically with one another in a first position and are detached from one another in a second position.

20. The charging cable of claim 19 wherein one of the first and second locking elements has a groove and the other has a protrusion engaging the groove in the first position.

21. The charging cable of claim 19 wherein the first and second locking elements each have catch configured to engage with one another in the first position.

22. The charging cable of claim 19 wherein the first and second locking elements form a bayonet fastener.

23. The charging cable of claim 19 wherein one of the first and second locking elements has an internal thread and the other has an external thread, the internal and external threads configured to engage one another in the first position.

24. The charging cable of claim 19 wherein the locking device further includes an actuator for relative movement of the first and second locking elements between the first position and the second position, and the actuator is an electric motor, a stepper motor or an electromagnet.

25. The charging cable of claim 16 further including a control unit for controlling the locking device, the control unit communicatively connected to the locking device and one of the first and second connectors.

26. The charging cable of claim 16 wherein the first and second adapter elements have a diameter that is no more than 200 mm.

27. The charging cable of claim 26 wherein the first and second adapter elements have a diameter that is no more than 100 mm.

28. The charging cable of claim 27 wherein the first and second adapter elements have a diameter that is no more than 60 mm.

29. A mobile charging device for charging an electric vehicle, the mobile charging device comprising:
a charging cable having a network-side first connector for connecting the charging cable to a power network;
a load-side second connector for connecting the charging cable to the electric vehicle; and
an adapter assembly between the first connector and the second connector of the charging cable, the adapter assembly including:
a first adapter element and a second adapter element detachably connected to one another, wherein one of the first and second adapter elements is electrically connected to the first connector and the other one of the first and second adapter elements is electrically connected to the second connector;
a locking device configured to automatically lock the first and second adapter elements to one another in response to an event associated with charging the electric vehicle; and
a charge control device for controlling charging the electric vehicle, the charge control device being between one of the first and second connectors and the adapter assembly.

30. A method for charging an electric vehicle, the method comprising the steps of:
providing a charging cable having (a) a network-side first connector for connecting the charging cable to a power network, (b) a load-side second connector for connecting the charging cable to the electric vehicle, and (c) an adapter assembly between the first and second connectors, the adapter assembly having a first adapter element and a second adapter element detachably connected to one another;
connecting the first and second adapter elements to one another;
connecting the first connector to the power network and the second connector to the electric vehicle; and
locking the first and second adapter elements to one another with a locking device, the locking taking place automatically in response to an event associated with charging the electric vehicle.

31. The method of claim 30 wherein the event associated with charging the electric vehicle is the connection of the second connector to the electric vehicle or startup of charging the electric vehicle.

32. The method of claim 30 further comprising the steps of:
recognizing the event associated with charging the electric vehicle by a control unit; and
actuating the locking device with the control unit to lock the first and second adapter elements.
